(19) United States
(12) Patent Application Publication
(10) Pub. No.: US 2026/0349868 A1
(43) Pub. Date: Nov. 5, 2026

(54) METHODS AND SYSTEMS FOR IMPROVING AUTONOMOUS TELLER MACHINES ("ATMs")

(71) Applicant: Bank of America Corporation, Charlotte, NC (US)

(72) Inventors: Giriraj Dipeshbhai Shah, Ahmedabad Gujarat (IN); Palakben Dilipkumar Patel, Mahesana Gujarat (IN); Ageysingh Laxmansingh Chauhan, Ahmedabad (IN); Saurabh Gupta, New Delhi (IN); Sweety Maulin Patel, Ahmedabad (IN); Akshita Agarwal, Gandhinagar Gujarat (IN)

(21) Appl. No.: 19/175,219

(22) Filed: Apr. 10, 2025

(51) Int. Cl. G06F 11/07; H04L 9/08

(52) U.S. Cl. CPC G06F 11/0793; G06F 11/0709; H04L 9/0852

(57) ABSTRACT

A method for correcting an error located within an autonomous teller machine (“ATM”) includes experiencing a difficulty at the ATM and instantiating satellites in place of a primary connection which is experiencing the difficulty, generating an error log at the ATM, transmitting the error log to a server, encrypting the error log at a decentralized end node, receiving the encrypted error log at the server, authenticating, via decrypting, the error log, executing a forward and backward propagation at a quantum generative adversarial network (“QGAN”) to generate a predictive solution, transmitting the predictive solution to a technical agent to approve, analyzing and approving the predictive solution at the technical agent, transmitting the predictive solution to the ATM upon approval, and installing the predictive solution at the ATM.

### FIELD OF TECHNOLOGY

Aspects of the disclosure relate to autonomous teller machines (ATMs”) and satellites.

### BACKGROUND OF THE DISCLOSURE

Autonomous teller machines (“ATMs”) are computers that interact with clients and perform teller operations. Clients can interact with ATMs and execute transactions at any time of day and night. As such, ATMs are specifically useful when a financial center or teller is unavailable.

At times, ATMs can incur technical difficulties. Technical difficulties may include difficulties that are related to connectivity, malicious activities and/or any other suitable difficulties. When the ATMs incur technical difficulties, the ATMs may therefore be unable to operate. Inoperable ATMs may inconvenience clients who are therefore unable to execute transactions at various times.

At times, a technical difficulty, such as a disconnection, may affect a transaction during transaction processing. As such, transactions processed during a disconnection may fail, may be misplaced, may become wedged within the ATM, may become wedged between the ATM and an associated server and/or may be otherwise affected.

Therefore, it would be desirable to create methods and systems for improving connectivity at ATMs to minimize ATM downtime.

### SUMMARY OF THE DISCLOSURE

Apparatus, methods and systems for improving connectivity at ATMs to minimize ATM downtime are provided.

Systems may include an autonomous teller machine (“ATM”) . The ATM may be connected to a server. The ATM may be connected to the server via a first connection method and a second connection method. The first connection method and the second connection method may be connected to the server and the ATM simultaneously. The first connection method and the second connection method may be via a wire connection, a wireless connection and/or any other suitable connections. Transactions performed at the ATM may be processed via the first connection method.

It should be noted that the first connection method may continuously transmit status signals to the server. The signals may be referred to as “OK” signals. The ATM may identify itself as operational to the server. The server may receive the OK signals from the ATM. As such, when the ATM is not operations and therefore stops transmitting OK signals, the server may identify a failure at the ATM.

In response to the server identifying a failure at the ATM, the ATM may self-identify the failure and transmit all transactions being executed via the ATM to the server via a satellite connection. After transmitting the transactions to the server, the ATM may generate an error log. The ATM may transmit the error log to a decentralized end node for encryption. The ATM may send the error log to the decentralized end node via the satellite connection.

The ATM may receive the encrypted error log from the decentralized end node via the satellite connection. The ATM may transmit the encrypted error log to the server via the satellite connection.

The server may initiate a solution creation. The solution creation may be initiated via a quantum generative adversarial network (“QGAN”). The server may send the solution to the ATM via the satellite connection. The ATM may execute the received solution. The ATM may be fully operational upon executing the received solution.

The ATM may include a plurality of connection methods. The plurality of connection methods may include two connection methods. The plurality of connection methods may include any suitable number of connection methods. A first connection method (or connection device) may include a network-based connection, such as the Internet (accessed via an Ethernet or wireless connection, such as, for example, Wi-Fi, hotspot, Bluetooth, etc.) or any other suitable connection method. A second connection method (or connection device) may include a satellite based connection, or any other suitable connection method.

The first connection method and the second connection method may execute simultaneously. As such, when a first connection method fails, the ATM may continue executing, without interruption, using the second connection method.

It should be noted that other suitable hardware or software systems, in addition to ATMs, may utilize the first connection method and the second connection method. Other suitable hardware or software systems may include cloud computing systems, Wi-Fi systems and/or any other suitable systems.

### BRIEF DESCRIPTION OF THE DRAWINGS

The objects and advantages of the invention may be apparent upon consideration of the following detailed description, taken in conjunction with the accompanying drawings, in which like reference characters refer to like parts throughout, and in which:

FIG. 1 shows an illustrative diagram in accordance with the principles of the disclosure;

FIG. 2 shows another illustrative diagram in accordance with the principles of the disclosure;

FIG. 3 shows yet another illustrative diagram in accordance with the principles of the disclosure;

FIG. 4 shows still another illustrative diagram in accordance with the principles of the disclosure;

FIG. 5 shows another illustrative diagram in accordance with the principles of the disclosure;

FIG. 6 shows yet another illustrative diagram in accordance with the principles of the disclosure;

FIG. 7A shows still another illustrative diagram in accordance with the principles of the disclosure;

FIG. 7B shows an illustrative diagram in accordance with the principles of the disclosure; and

FIG. 8 shows another illustrative diagram in accordance with the principles of the disclosure.

### DETAILED DESCRIPTION OF THE DISCLOSURE

Systems for improving connectivity at autonomous teller machine (“ATM”) to minimize ATM downtime are provided.

Systems may include an ATM, one or more satellite dishes, one or more satellites, a server, a decentralized end node, a quantum generative adversarial network (“QGAN”), a technical agent and/or any other suitable components.

The server may be located at the same physical location as the ATM. The server may be located at a physical location remote from the ATM. The server may be electronically linked to the ATM. The server may process a plurality of executables executed at the ATM. The executables executed at the ATM may be electronic transactions and/or any other suitable executables. The ATM may continuously or periodically transmit a status signal to the Server. The status signal may inform the server about the status of the ATM. The status of the ATM may include a notification of whether the ATM is fully operational.

The ATM may include a plurality of status signals. A first status signal may be an “OK” signal. The OK signal may indicate that the ATM is fully operational. A second status signal may be an “NG” signal. The NG signal may indicate that the ATM is not fully operational. The NG signal may include various error codes. The various error codes may explain to the server different errors that the ATM may be experiencing. In some embodiments, the ATM may stop sending status signals to the server. The server may detect that the ATM stopped sending status signals. In response to detecting that the ATM stopped sending status signals, the server may determine that the ATM is not fully operational.

The server may store data relating to executables that were executed at the ATM. As such, the server may synchronize (“sync”) the executables executed at the ATM with the server. The executables executed at the ATM may be transmitted to the server. The server may store the executables, or executable data, received from the ATM in a memory location within the server. In some embodiments, the server may perform the executables. In other embodiments, the server may refer to the stored executables to determine a solution to an error.

When experiencing a malfunction, the ATM may generate an error log. The error log may include data relating to the malfunction and/or data relating to the ATM. Data about the malfunction may include a time of the malfunction, an error code associated with the malfunction, and/or any other suitable data about the malfunction. Data about the ATM may include a location of the error, a software component and/or hardware component within the ATM in which the error occurred, a functionality level of the ATM and/or any other suitable ATM information.

A functionality level of the ATM may be understood to mean an executable level. The executable level may include the executables the ATM may execute in the ATM's current state. The functionality level may be included in a plurality of functionality levels. The functionality level may be structured in a tiered hierarchy. As such, each functionality level may include a limited number of functionalities which the ATM may be operable to execute. Each additional level may include additional functionalities which the ATM may be operable to execute. In one example, a first functionality level may enable the ATM to process withdrawals. A second functionality level may enable the ATM to process withdrawals and deposits. A third functionality level may enable the ATM to process withdrawals, deposits and transfers. A fourth functionality level may enable the ATM to process withdrawals, deposits, transfers and balances.

It should be noted that the different functionality levels may be customizable and/or unique for different ATMs. It should be further noted that the different functionality levels may be different for each error associated with the ATM. As such, some errors may cause the ATM to fail to operate. For example, a first error may remove the ATM from a first functionality level. As such, (i.e., an ATM removed from a first functionality level) the ATM may be inoperable. A second error may remove the ATM from the second functionality level, as such the ATM may execute only a first level of executables. A first level of executables may include withdrawals. There may be a plurality of other suitable functionality levels that include any other suitable number of executables.

The one or more satellite dishes may be located at the ATM. In some embodiments, the one or more satellite dishes may be located remote from the ATM. The one or more satellite dishes may be located at any suitable location. A suitable location may include a roof top, a pole or any other suitable locations. The ATM may transmit the error log to the satellite via the one or more satellite dishes. The one or more satellite dishes may electronically convert the error log into a signal. The one or more satellite dishes may transmit the signal to the satellite. The satellite may transmit the signal to a second satellite dish. The second satellite dish may retrieve the error log from the signal. The second satellite dish may transmit the error log to the server.

It should be noted that the error log may include sensitive data about the ATM, transactions and/or any other suitable confidential data. Therefore, the error log may be encrypted to prevent users of malicious intent from retrieving the error log.

The error log may be encrypted using the decentralized end node. A decentralized end node may be understood to refer to a computing environment that uses more than one node. Additionally, the decentralized end node does not have a central server. As such, each of the nodes can equally control the data transmission. Decentralized end nodes provide privacy and security to systems.

The decentralized end node may encrypt the error log. The decentralized end node may transmit the error log to the one or more satellite dishes. The decentralized end node may be located remote from the ATM, the one or more satellites and/or the server. The decentralized end node may use quantum public encryption keys to encrypt the error log. The quantum public encryption keys ensure that the data is secure and inaccessible throughout transmission.

Quantum public encryption keys, for purposes of the application, may be encryption keys that use quantum mechanics. Quantum public encryption keys may have a pair of corresponding quantum private encryption keys. The decentralized end node, one or more satellites and/or the server, may use the quantum private encryption keys to decrypt the error log. It should be noted that other data may be encrypted and transmitted to the satellite. Such other data may include user data, transaction data, ATM data and/or any other suitable data.

The one or more satellites may be lower orbit satellites, also referred to as low earth orbits (“LEO”) , or any other suitable satellites. A lower orbit satellite may be understood to refer to a satellite that orbits the Earth at an altitude of approximately 1,200 miles or less. Lower orbit satellites may be used for communications and a variety of other purposes. The one or more satellites may be registered with the ATM. The one or more satellites may be registered with the server. The one or more satellites may have a continual connection with the ATM and the server. The one or more satellites may periodically connect to the ATM and the server.

The one or more satellites may provide connectivity between the ATM and the server. Connectivity may include a communication channel or any other suitable connection method. The one or more satellites may provide constant and/or periodic connectivity between the ATM and the server. The one or more satellites may operate together with a primary connection method. The primary connection method may include the Internet and/or any other suitable connection method.

Because both connection methods work together, or at the same time, when a primary connection method has difficulties, the ATM may continue to work using the secondary connection method. As such, in an event that the ATM loses a first connectivity, the satellite may be used and the ATM may continue to work without restarting or disconnecting.

The server may authenticate the received error log. The authentication may include retrieving the error log using the quantum private encryption keys. The authentication may further include authenticating the transmission channel through which the error log was transmitted. Authenticating the transmission channel may include verifying that the transmission channel is secure and associated with the server and the ATM.

### Upon Authenticating the Error Log, the Server May Process the

error log. During the processing, the server may transmit the error log to the QGAN. The QGAN may include multiple neural networks. The QGAN may be trained to provide predictive solutions for multiple failures that arise within ATM systems. The QGAN may be trained using historical data, quantum-based error code patterns and/or any other suitable data.

The Q-GAN model may be included in a quantum computing platform. A quantum computing platform may include a quantum processor. The quantum processor may operate using quantum bits (“qubits”). The quantum computing platform may include cooling hardware. The cooling hardware may be used to maintain the qubits within a few thousandths of a degree of absolute zero (kelvin). The qubits may be cooled to eliminate thermal noise and vibrations, which may destroy the information contained in the qubits.

The quantum computing platform may be in electronic communication with a classical computing platform. The classical computing platform may include a network of one or more computing devices. Computing devices may include desktop computers, laptops, smartphones, tablets, mainframe computers, supercomputers, minicomputers and/or any other suitable computing devices. The network may include an edge network, a local area network (“LAN”) , a wide area network (“WAN”), a decentralized network, a cloud-based network or any other suitable network. The classical computing platform may be a computing system operating using binary digits and/or bits.

The Q-GAN model may include a Q-GAN generator and a Q-GAN discriminator. The Q-GAN model may include one or more Q-GAN generators and one or more Q-GAN discriminators. Each of the one or more Q-GAN generators and Q-GAN discriminators may include one or more of the following: neural networks, parameterized perceptrons, quantum algorithms, classical algorithms, machine learning components, logic gates, quantum logic gates and/or any other suitable components.

Transmitting data to the Q-GAN model may include feeding raw data to a Q-GAN generator. Feeding the raw data may include providing the raw data to the Q-GAN generator. Feeding the raw data may include supplying the raw data. Raw data may include randomized data. The randomized data may be retrieved from a storage location. The randomized data may include unsorted data. The randomized data may include public data. The randomized data may include private data. The randomized data may include any suitable data.

Transmitting data to the Q-GAN model may include feeding real training data to Q-GAN discriminator. Feeding the real training data may include providing the real training data to the Q-GAN discriminator. Feeding the real training data may include supplying the real training data. The real training data may include data from previous iterations of the Q-GAN model. The real training data may include data from iterations of other Q-GAN models. The real training data may include data that is organized, sorted and labeled for training purposes. The real training data may include any suitable training data.

The methods may include establishing logical parameters for the Q-GAN model. The logical parameters may be used to identify criteria for processes within the Q-GAN generator and the Q-GAN discriminator. Establishing logical parameters may include structuring the training data set with a section for the raw data and a section for the real training data.

The Q-GAN generator and the Q-GAN discriminator may be trained. Training the Q-GAN generator may be simultaneous to training the Q-GAN discriminator. The Q-GAN generator may include at least one neural network. The Q-GAN discriminator may include at least one neural network. The neural networks may be feed forward neural networks. In feed forward neural networks data may flow from input nodes. The data may flow from input nodes through hidden nodes. The data may flow from the hidden nodes out of output nodes. The neural networks may be trained using a backpropagation algorithm. The backpropagation algorithm may include a gradient estimation method. The backpropagation algorithm may compute a gradient of a loss function with respect to the weights of the neural network for a single input-output example. The backpropagation algorithm may compute the gradient one layer at a time, iterating backward from the last layer to avoid redundant calculations.

The training may include executing one or more training cycles. Each training cycle may include one or more of the following steps. The Q-GAN generator may generate one or more quantum states representing NPI. Quantum states may include wave functions, vector quantum states or any other suitable quantum states. The Q-GAN generator may include parameters. The parameters may be used to generate the one or more quantum states.

The Q-GAN generator may transmit the one or more quantum states to the Q-GAN discriminator. The Q-GAN discriminator may assign a confidence score to each of the one or more quantum states. The Q-GAN discriminator may be trained using the real training data. The real training data may include labeled NPI. Through the training, the Q-GAN discriminator may determine a set of benchmarks for confirming that received NPI is real/actual NPI. Upon receiving the one or more quantum states representing NPI, the Q-GAN discriminator may use the set of benchmarks to determine if the quantum states correspond to real/actual NPI. Based on the set of benchmarks, the Q-GAN discriminator may assign the confidence score. The confidence score may represent an indication that the one or more quantum states are transmitted from the real training data rather than from the Q-GAN generator. The confidence score may be a percentage such as 5%, 10%, or any other suitable percentage. The confidence score may be a decimal number such as, 0.1, 0.2, 0.3 or any other suitable decimal number. The confidence score may be a whole number such as 1, 2 and 3 or any other suitable whole number.

The Q-GAN discriminator may transmit the confidence score for each quantum state from the Q-GAN discriminator to the Q-GAN generator. Based on the received confidence score the generator may adjust the parameters to generate quantum states that more closely represent NPI.

The one or more training cycles may be executed until the Q-GAN generator identifies a fixed-point at which the Q-GAN generator generates quantum states representing NPI with one or more parameters in common with the real training data. The fixed point may include the point where false/untrue data generated by the Q-GAN generators may be indistinguishable from the data included in the real training data. The fixed-point may include a Nash equilibrium state. The Nash equilibrium state may include a state in which the Q-GAN generator and the Q-GAN discriminator determine a state where both the Q-GAN generator and the Q-GAN discriminator would not gain by changing their own parameters or benchmarks.

The fixed-point may be identified using a Jensen-Shannon divergence method of measuring a similarity between two or more confidence score distributions. Each of the two or more confidence score distributions may include one or more confidence scores captured from the Q-GAN discriminator within a specific time period. By measuring the similarity between two or confidence score distributions of the generated quantum states, methods may include measuring the extent to which the generated quantum states are similar to or different from the real/actual NPI. The Nash equilibrium state may be reached when it is determined, using the Jensen-Shannon divergence method, that the generated quantum states are the same or substantially the same as the real/actual NPI.

The fixed-point may be identified using the minimax theorem by Von Neumann. The minimax theorem conveys that in zero-sum matches with perfect or substantially perfect information (i.e., in which players know at each time all moves that have taken place so far), there exists a pair of strategies for both players that allows each to minimize their maximum losses. The minimax theorem may be used to find benchmarks/parameters that the Q-GAN generator and the Q-GAN discriminator should each use to determine the most profitable outcomes. Using the minimax theorem, the Q-GAN generator and the Q-GAN discriminator may be able achieve the Nash equilibrium state.

Any other suitable algorithm or theorem to achieve the Nash equilibrium state. The fixed point may correspond to a threshold confidence score. The threshold confidence score may be a minimum confidence score that corresponds to the Nash equilibrium. The Q-GAN model may execute a plurality of training cycles until the confidence score reaches/passes the threshold confidence score. The threshold confidence score may be determined using the Jensen-Shannon divergence method, minimax theorem by Von Neumann and/or any other suitable algorithm.

Historical data may include data about historical connection failures and resolutions, historical data about the current connection failure, historical data about the ATM including historical failures associated with the ATM and/or any other suitable historical data. Quantum-based error code patterns may be understood to refer to a specific arrangement of quantum bits (“qubits”) designed to detect and correct errors that occur during quantum computations. The quantum-based error code pattern may protect the information stored in a quantum system by encoding the data across multiple qubits, allowing for the identification and repair of errors.

The QGAN may include the quantum generator. The QGAN may include a quantum discriminator. The quantum generator may execute a forward propagation algorithm. The forward propagation algorithm may include a training algorithm that feeds data through the network layers. The forward propagation algorithm may feed input data from the input layer to the output layer. The forward propagation algorithm may perform calculations at each layer to generate a final output prediction. The final output prediction may also be referred to as a predictive solution. The predictive solution may be based on the input data. The quantum generator may output the predictive solution to the quantum discriminator.

The quantum discriminator may execute a back propagation algorithm. The back propagation algorithm may include a training algorithm that calculates if there is an error between the input and the predictive solution. The back propagation algorithm may further propagate the error backwards through the network layers. The quantum discriminator may transmit an approval algorithm or disapproval algorithm of the predictive solution to the quantum generator. The quantum generator may continually output predictive solutions until the quantum discriminator transmits an approval algorithm. The QGAN may provide the predictive solution to the Server. The predictive solution may be used to correct the error associated with the error log.

The technical agent, for purposes of this application, may be an artificial intelligence (“AI”) agent or any other suitable agent. The agent may be trained to analyze and determine whether the predictive solution provides a solution operable to correct the error associated with the error log.

Upon outputting a predictive solution operable to correct the error, the server may trigger an alert to the technical agent. The alert may include the error log and the predictive solution. The technical agent may analyze the error log and the predictive solution. The technical agent may determine whether the predictive solution is operable to correct the error. The technical agent may determine whether the predictive solution is operable to correct the error based on previous errors and/or any other suitable data. When the technical agent determines that the predictive solution is suitable to correct the error, the technical agent may provide an approval to the predictive solution.

Upon the approval of the predictive solution from the technical agent, the technical agent may transmit the solution to the server. The server may transmit the predictive solution to the satellite dish associated with the server. The satellite dish may electronically convert the predictive solution into a signal. The one or more satellite dishes associated with the server may transmit the signal to the satellite, or any other number of satellites. The satellite may transmit the signal to the one or more satellite dishes associated with the ATM. The one or more satellite dishes associated with the ATM may retrieve the predictive solution from the signal. The one or more satellite dishes may transmit the predictive solution to the ATM. The ATM may authenticate the transmission of the predictive solution. Upon authentication of the predictive solution, the ATM may use the predictive solution to correct the error associated with the error log. The ATM may install any required files and/or software necessary to correct the error associated with the error log.

It should be noted that in some embodiments the required files and/or software may be self-executing. As such, the ATM may not need to install any required files and/or software to correct the errors. In such embodiments, the ATM may execute suitable actions to execute the predictive solution. In certain embodiments, the ATM may install the necessary files and/or software. The ATM may restart automatically after installing the necessary files. Upon restarting, the ATM may again send a status signal directly to the server. The server may synchronize operations within the ATM.

Systems for improving ATM services are provided. Systems may include an ATM, one or more satellite dishes, one or more satellites, a server, a decentralized end node, a technical agent and a video capture device.

A user of malicious intent may attempt to execute a fraudulent transaction at the ATM. A user of malicious intent may attempt to coerce a second user to execute a fraudulent transaction at the ATM. The user of malicious intent may maliciously retrieve money from the ATM. The ATM may include the video capture device. The video capture device may continually video the ATM and an environment surrounding the ATM.

The video capture may capture a current user executing a transaction at the ATM. A camera located within the ATM may capture the video capture. The camera may be located on top of the ATM, near the ATM or at any other suitable location. The user executing a transaction at the ATM may be uninformed regarding the camera that is performing the video capturing. As such, users of malicious intent may be unaware of the video capture device. The ATM may store the video capture at the ATM and/or server in the memory.

The ATM may retrieve a portion of the video and/or the complete video capture from memory. The ATM may include safety features for preventing malicious activity at the ATM. Safety features may include a biometric identification executed automatically. The biometric identification may include a biometric scan executed automatically. The biometric scan may include a facial scan of the user, an iris scan of the user, a fingerprint of the user, a retinal identification of the user, a keystroke model of the user, palm vein recognition as well as any other suitable biometric identification. It should be noted that the ATM may execute a biometric identification of each user when executing a transaction at the ATM. The user may be informed regarding the biometric identification. The user may be uninformed regarding the biometric identification because the biometric identification may be executed automatically.

The video capture device may receive a signal that over a predetermined number of safety features have been breached. The ATM may generate a malicious activity log. The malicious activity log may include a list of safety features that were breached, a video capture of the current user executing a transaction at the ATM and/or any other suitable data associated with the user of malicious intent and/or the ATM.

The malicious activity log may be encrypted. The encryption may prevent users of malicious intent from retrieving the log. The malicious activity log may include sensitive data relating to the ATM, one or more users, one or more transactions and/or any other suitable data. The malicious activity log may be encrypted using a decentralized end node. The decentralized end node may use quantum public encryption keys to encrypt keys to encrypt the log and/or any other suitable data. The decentralized end node may be located remote from the ATM, the one or more satellites, and/or the server. The decentralized end node may transmit the malicious activity log to the ATM and/or one or more satellites. The quantum public encryption keys may ensure that the data is secure and inaccessible throughout data transmission.

The video may capture a video of an environment surrounding the ATM. The video capture may include a user of malicious intent coercing a second user at the ATM. A coercion in the video capture may trigger a breach of one of the predetermined security features. The ATM may detect a breach of the security features within the stored video. As such, a malicious activity log may be generated in response to the detected breach.

The ATM may transmit the malicious activity log to the one or more satellites using the one or more satellite dishes. The one or more satellite dishes may transmit a signal including the malicious activity log and/or any other suitable data to the satellite. The satellite may transmit the malicious activity log to the server. It should be noted that other data may be encrypted and transmitted to the satellite.

The server may receive the malicious activity log. The server may authenticate the malicious activity log and/or the other suitable data. The authentication process may include retrieving the malicious activity log using the quantum private keys. The authentication process may further include authenticating the channel through which the malicious activity log and/or additional data was transmitted. Authenticating the channel may include verifying that the channel through which the malicious activity log was transmitted is secure. Authenticating the channel may further include verifying that the channel is associated with the server and the ATM.

Upon authenticating the malicious activity log, the server may process the malicious activity log. During the processing, the server may transmit the malicious activity log to the QGAN. The QGAN may be trained to provide predictive solutions for multiple security breaches within ATM systems. The QGAN may be trained using historical data, malicious activities and/or other suitable data.

Historical data may include data about historical malicious activities and historical incidents. Historical data may include previous video captures of users executing malicious activities. Malicious activities may include a plurality of malicious activities that are performed at the ATM. Malicious activities include using another user's card to withdraw money, coercing a user to withdraw money on behalf of another user and/or any other suitable malicious activity.

The QGAN may include the quantum generator. The QGAN may include the quantum discriminator. The quantum generator may execute a forward propagation algorithm. The quantum generator may generate a predictive solution. The quantum generator may output the predictive solution to the quantum discriminator. The predictive solution may include a solution to prevent the ATM from executing the malicious transaction associated with the malicious activity log. Predictive solutions may include stating at the ATM “unable to dispense funds” preventing the ATM from dispensing funds to a malicious user. Prevention may also include displaying a predictive solution on a graphical user interface (“GUI”) associated with the ATM. Any other suitable solutions that prevent the ATM executing a malicious activity may be used. Any other suitable solutions that prevent a malicious activity may be generated.

The quantum discriminator may execute a back propagation algorithm. The quantum discriminator may transmit an approval algorithm or disapproval algorithm of the predictive solution to the quantum generator. The quantum generator may continually generate predictive solutions until the quantum discriminator transmits an approval algorithm. Upon receiving an approval, the QGAN may transmit the predictive solution to the server.

The technical agent, for purposes of this application, may be an artificial intelligence (“AI”) agent or any other suitable agent. The technical agent may be trained to analyze and determine if the predictive solution is operable to prevent the malicious activity.

Upon outputting a predictive solution operable to prevent the malicious activity, the server may trigger an alert to the technical agent. The alert may include the malicious activity log and the predictive solution. The technical agent may analyze the malicious activity log and the predictive solution. The technical agent may approve of the predictive solution. The technical agent may fail to approve the predictive solution.

In an embodiment where the technical agent disapproves of the predictive solution, the technical agent may transmit a disapproval to the QGAN. The QGAN may execute a forward propagation algorithm and a generate another predictive solution. The technical agent may approve the predictive solution. The technical agent may fail to approve the predictive solution. The QGAN may continually generate a predictive solution until the technical agent approves the predictive solution.

Upon approving the predictive solution, the technical agent may transmit the solution to the server. It should be noted that the predictive solution may be transmitted as a signal. The server may transmit the predictive solution to the one or more satellite dishes associated with the server. The one or more satellite dishes associated with the server may transmit the predictive solution to the one or more satellites. The one or more satellites may transmit the predictive solution to the one or more satellite dishes associated with the ATM. The one or more satellite dishes associated with the ATM may transmit the predictive solution to the ATM. The ATM may authenticate the predictive solution. Upon authentication of the predictive solution, the ATM may use the predictive solution to install any required files and/or software necessary to prevent the malicious activity.

It should be noted that in some embodiments the files may be self-executing. As such, the ATM may not need to install any file or software to prevent the malicious activity. In such embodiments, the ATM may execute suitable actions to perform the predictive solution. In certain embodiments, the ATM may install the necessary files and/or software. The ATM may restart automatically after installing the necessary files. Upon restarting, the ATM may again send a status signal directly to the server. The user of malicious intent may prevent a malicious activity.

Systems and methods described herein are illustrative. Systems and methods in accordance with this disclosure may now be described in connection with the figures, which form a part hereof. The figures show illustrative features of system and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

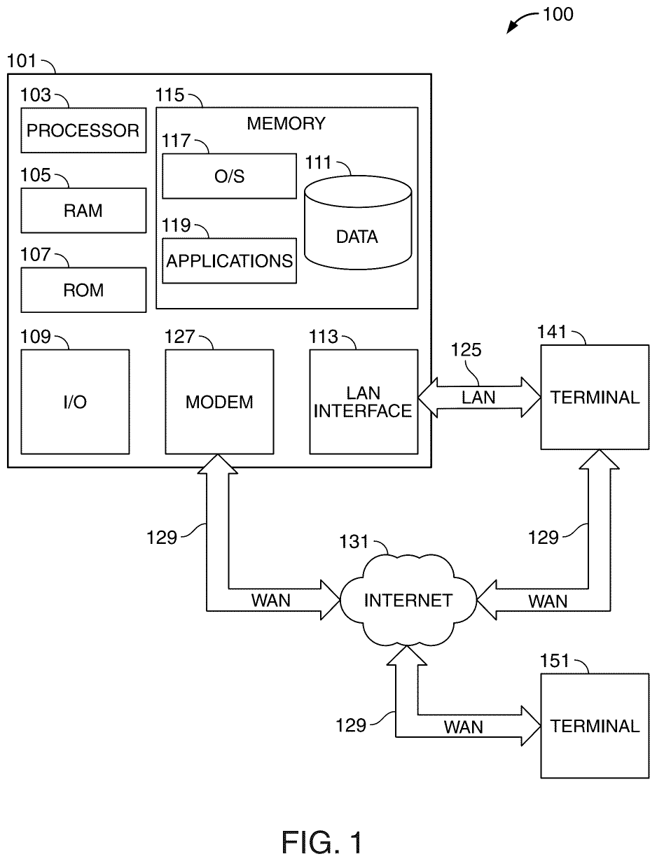

FIG. 1 shows an illustrative block diagram of apparatus 100 that includes computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. Microprocessors 103 may also execute all software running on the computer 101—e.g., the operating system 117 and applications 119 such as an artificial intelligence implemented termination program and security protocols. Other components commonly used for computers, such as EEPROM or Flash memory or any other suitable components, may also be part of the computer 101.

Memory 115 may be comprised of any suitable permanent storage technology—e.g., a hard drive or other non-transitory memory. ROM 107 and RAM 105 may be included as all or part of memory 115. The memory 115 may store software including the operating system 117 and application(s) 119 (such as an artificial intelligence implemented termination program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may be comprised of any suitable permanent storage technology—e.g., a hard drive or other non-transitory memory. The memory may store software including an operating system and any application(s) (such as an artificial intelligence implemented termination program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of Internet connection (e.g., cellular or Wi-Fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, Wi-Fi, cellular networks or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can operate in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an artificial intelligence implemented termination program and security protocols, as well as other programs. In an embodiment, one or more programs, or aspects of a program, may use one or more artificial intelligence/machine learning (“AI/ML”) algorithm(s).

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

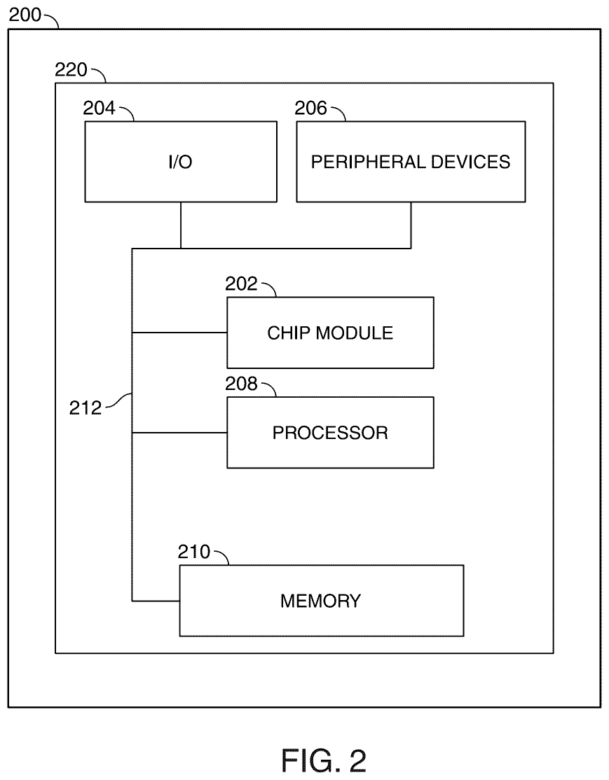

FIG. 2 shows illustrative apparatus 200 that may be configured in accordance with the principles of the disclosure.

Apparatus 200 may be a server or computer with various peripheral devices 206. Apparatus 200 may include one or more features of the apparatus shown in FIGS. 1-8. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

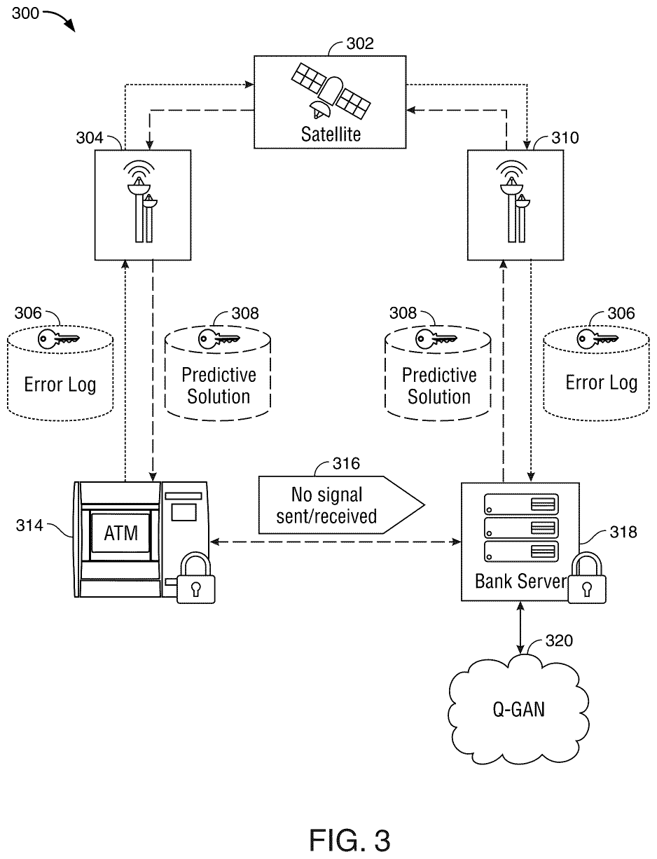

FIG. 3 shows an illustrative diagram. Diagram 300 shows a process for improving autonomous teller machines (“ATMs”). ATM 314 may connect to server 318. ATM 314 may connect to server 318 using at least one of a plurality of connections. A connection may include a network connection, an Internet connection, a satellite connection and/or any other suitable connection. Information, data and transactions may be transmitted from ATM 314 to server 318 using at least one of the connection methods. A first connection method may be the internet (not shown). It should be noted that the first connection method may be a default connection method. A second connection may be satellite 302. It should be noted that although the second connection method may not be a default connection method, the second connection method may execute continually.

When ATM 314 is fully operational, ATM 314 may transmit a status signal to server 318. The status signals may be transmitted continuously. The status signal may be transmitted periodically. ATM 314 may transmit a status signal using the first connection method or any other suitable connection method. Server 318 may receive the status signals and synchronize (“sync”) operations within ATM 314.

At times, the first connection method may fail. The first connection method may fail for at least one of a plurality of different reasons. When the first connection method fails, the second connection method may be used automatically. The second connection method may be continuously connected. Therefore, ATM 314 may work continuously even when transferring connection methods.

When the first connection method fails, ATM 314 may detect an error. The error may be the reason for the failure of the first connection method. The error may be a connection error, a software error, a configuration error or any other suitable error. Server 318 may not receive any status signal from ATM 314, as shown at 316. ATM 314 may generate error log 306. Error log 306 may include data about the error, ATM 314 machine identification (“ID”) number and any other suitable data.

It should be noted that error log 306 may be encrypted. A decentralized end node located remote from ATM 314, server 318 and satellite 302 may encrypt error log 306. Error log 306 may be encrypted using quantum public encryption keys. Error log 306 may be encrypted to prevent users of malicious intent from accessing the data within error log 306.

ATM 314 may use satellite dish 304 to transmit error log 306 to satellite 302. Satellite dish 304 may be located at ATM 314, remote from ATM 314 or at any other suitable location. Other suitable locations may include a rooftop above ATM 314, on top of a pole next to ATM 314 or any other suitable location. Satellite dish 304 may relay signals including error log 306 to satellite 302. It should be noted that satellite 302 may have been previously registered with ATM 314 and server 318. Satellite 302 may be registered with any other suitable hardware associated with a financial institution associated with ATM 314.

Satellite 302 may relay the signals, including error log 306 to satellite dish 310. Satellite dish 310 may be located either at server 318, remote from server 318 or at any other suitable location. Satellite dish 310 may receive the signals from satellite 302. Satellite dish 310 may relay the signals to server 318.

When server 318 receives the signals, including error log 306 and/or associated data, server 318 may authenticate error log 306 and/or associated data. Server 318 may transmit error log 306 to quantum generative adversarial network (“QGAN”) 320.

QGAN 320 may analyze error log 306 using a neural network. QGAN 320 may generate predictive solution 308. Predictive solution 308 may be encrypted. QGAN 320 may transmit predictive solution 308 to server 318. Server 318 may transmit predictive solution 308 to satellite dish 310. Satellite dish 310 may relay predictive solution 308, as signals, to satellite 302. Satellite 302 may relay the signals of predictive solution 308 to satellite dish 304. Satellite dish 304 may relay the signals of predictive solution 308 to ATM 314.

ATM 314 may authenticate predictive solution 308. ATM 314 may decrypt predictive solution 308 using the decentralized end node. ATM 314 may install any software or hardware and/or execute any suitable action to correct the error. ATM 314 may execute any suitable action based on predictive solution 308. Upon correcting the error, ATM 314 may begin to transmit status signals to server 318 again.

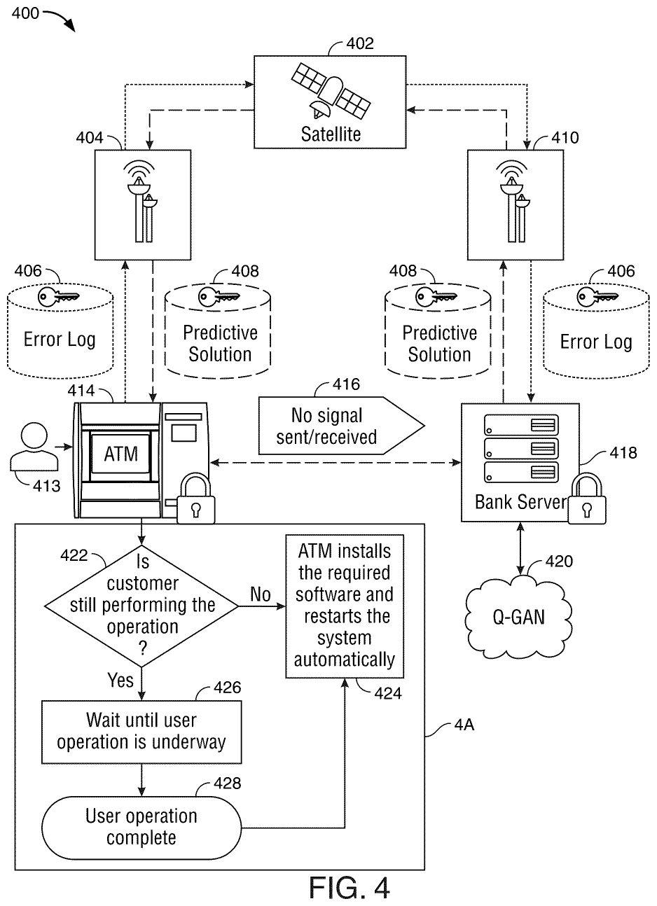

FIG. 4 shows another illustrative diagram. Diagram 400 shows the process of improving ATMs while a user is using the ATM. Diagram 400 may be similar, in some respects, to diagram 300. Accordingly, similar reference numerals are used to refer to similar components, except that the reference numerals begin with “4.”

User 413 may be performing a transaction at ATM 414 when a first connection method within ATM 414 fails or is otherwise disrupted. ATM 414 may use satellite 402 and the satellite dishes to avoid losing any information or data.

ATM 414 may execute query 4A. Query 4A may determine whether the user is still performing an operation, as shown at 422. If the user is not using the ATM, making the response “no”, ATM 414 may install the required software and restart the system automatically, as shown at 424. If the user is still performing an operation, the answer will be yes and ATM 414 will wait until the user finishes the operation from the front end, as shown at 426. Upon completion of the operation, as shown at 428, ATM 414 may install the required software and restart the system automatically, as shown at 424.

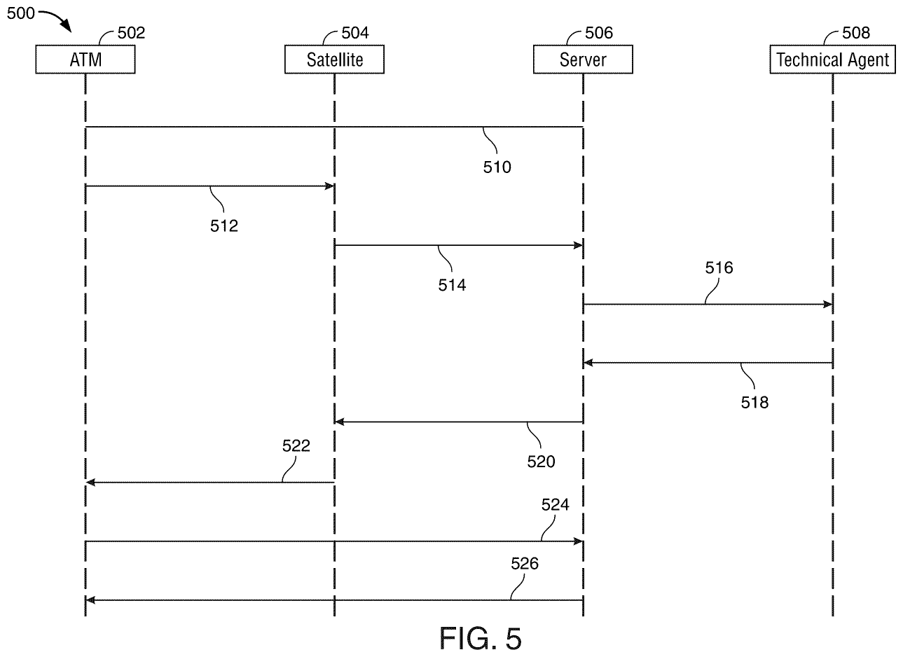

FIG. 5 shows an illustrative diagram. Illustrative diagram 500 includes ATM 502, satellite 504, server 506 and technical agent 508. ATM 502 may directly relate to ATM 314 and ATM 414. Satellite 504 directly relates to satellite 302 and satellite 402. Server 506 directly relates to server 318 and server 418.

ATM 502 may periodically send a status signal to server 506, as shown at step 510. The status signal may be a signal of the status of ATM 502. Server 506 may use the status signal to help monitor the status and health of ATM 502.

ATM 502 may experience a failure. The failure may be a software malfunction, a connectivity issue and/or any other suitable failure. ATM 502 may generate an error log. The error log may include the error details. Error details may include the time of malfunction, error code associated with the malfunction and/or any other suitable malfunction. ATM 502 may transmit the error log, as a signal, to satellite 504, as shown at step 512. Satellite 504 may amplify the incoming signal through the bank frequency. Satellite 504 may relay the data to server 506, as shown at step 514.

Server 506 may execute an authentication on the error log. Server 506 may process the error log. Server 506 may generate a predictive solution using an artificial intelligence machine learning (“AI/ML”) module. Server 506 may trigger an alert to technical agent 508 including an error log and predictive solution, as shown at step 516. Technical agent 508 may analyze the error log and predictive solution. Technical agent 508 may transmit the solution to server 506, as shown at step 518.

Server 506 may transmit the solution back to satellite 504, as shown at step 520. Satellite 504 may transmit the solution back to the ATM, as shown at step 522. ATM 502 may authenticate the predictive solution. Upon authentication, ATM 502 may install software and files and may restart the system automatically. After restarting, ATM 502 may again send status signals to server 506, as shown at step 524. Server 506 may synchronize operations with ATM 502, as shown at step 526.

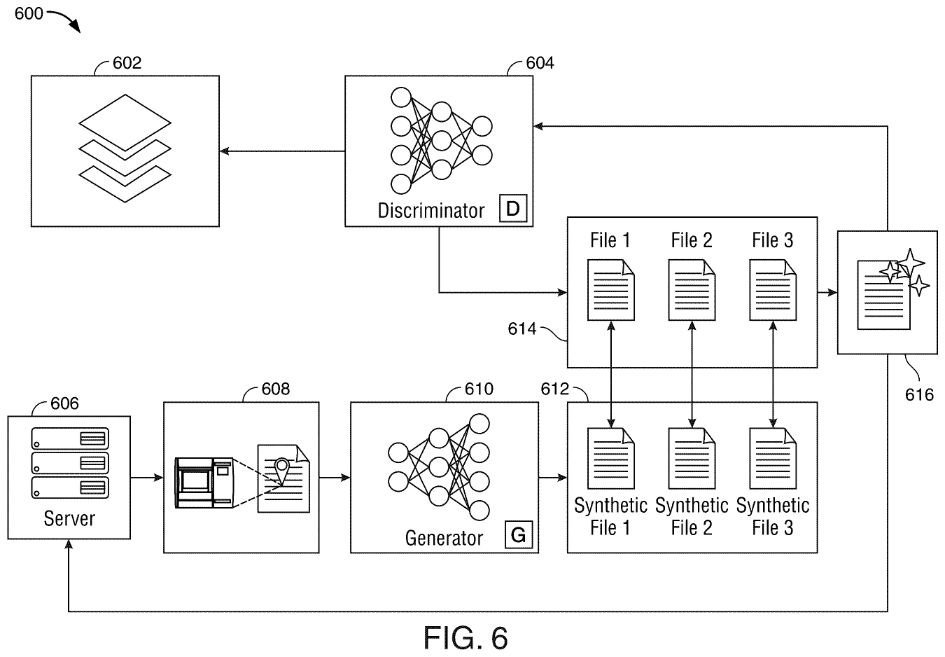

FIG. 6 shows illustrative diagram 600. Illustrative diagram 600 shows the process of providing a predictive solution for the error. Server 606 may transmit error with ATM machine identification (“ID”) and location 608 to quantum generator 610. Quantum generator 610 may generate synthetic files 612. Synthetic files may include predictive solutions. There may be a plurality of synthetic files generated by quantum generator 610. Synthetic files 612 may be transmitted to step 614 to be transmitted to quantum discriminator 604.

Quantum discriminator 604 may discriminate, using a neural network, the synthetic files to determine the output file or the predictive solution. The output file may be output file 616. Quantum discriminator 604 may generate trained data sets with possible issues and possible solutions.

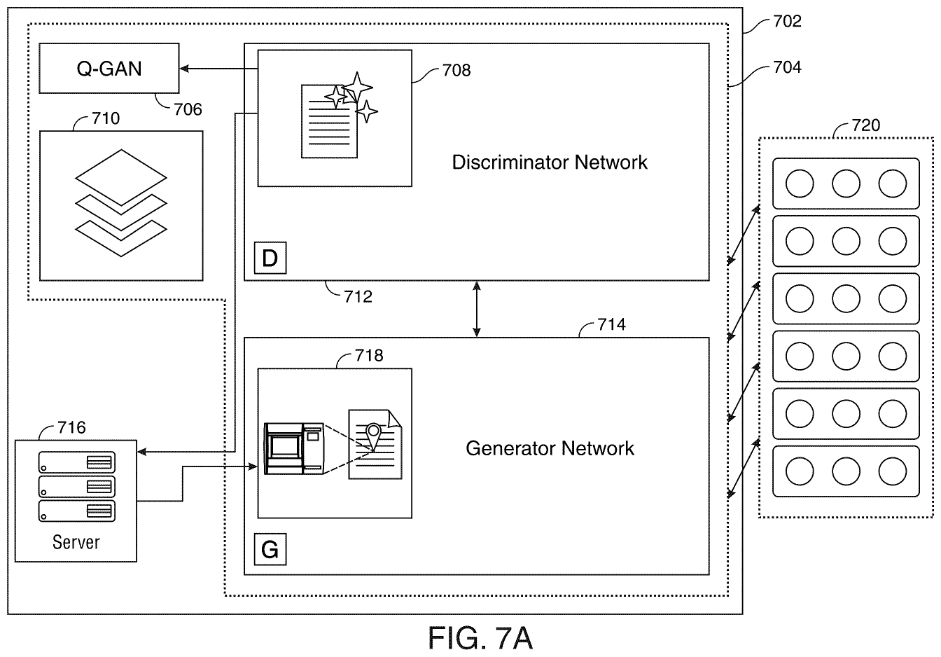

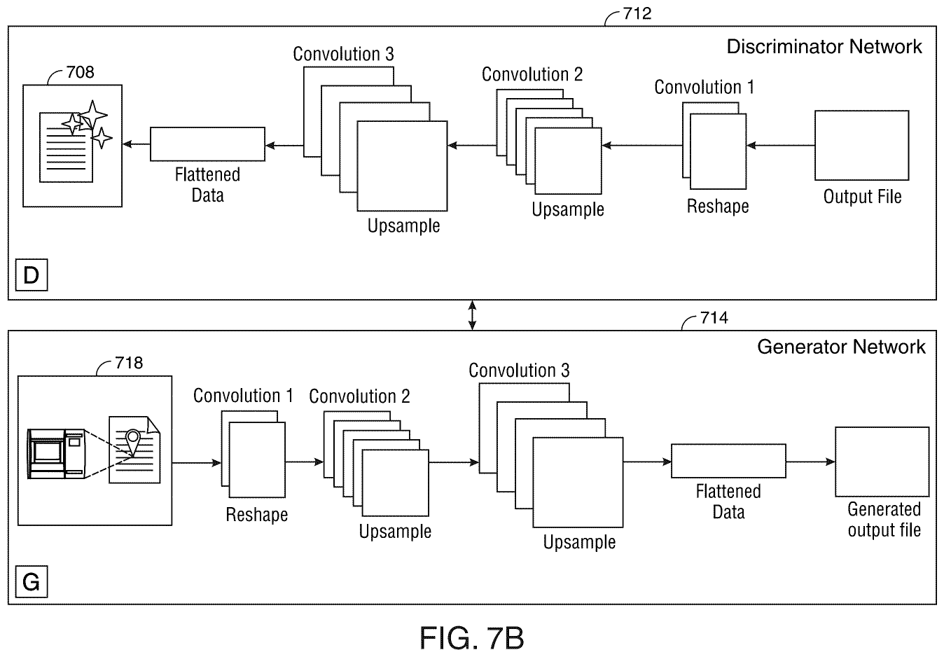

FIG. 7A shows an illustrative diagram. Server 716 may transmit error log 718 to quantum generator network 714. Quantum generator network 714 may generate synthetic output files based on the error. Attention mechanisms 720 allow the network to focus on specific parts of the input sequence. Attention mechanism 720 may assign weights to different parts of the input sequence. The weights may be assigned based on levels of importance. Attention mechanism 720 may allow the decoder to search across the input sequence for information at each step during the output sequence generation.

Quantum generator network 714 may transmit the output files to quantum discriminator network 712. Quantum discriminator network 712 may distinguish the output files. Quantum discriminator network 712 recognizes the error codes designed by QGAN based error codes. Quantum discriminator network 712 may analyze data sets associated with different log files to provide solutions based on quantum error codes and give the output file, or predictive solution 708. Quantum discriminator network 712 may transmit the analyzed output files to quantum generative adversarial network (“QGAN”) 706.

FIG. 7B shows a detailed illustration of quantum generator network 714 and quantum discriminator network 712. Quantum generator network 714 may receive error log 718 which includes the ATM machine ID and location.

Quantum generator network 714 may reshape error log 718, as shown at convolution 1. Quantum generator network 714 may execute an upsample of the reshape data, as shown at convolution 2. Upsampling may be understood to mean the process of increasing the number of samples in a dataset. Quantum generator network 714 may execute an additional upsampling, as shown at convolution 3. Afterwards, quantum generator network 714 may flatten the data. Quantum generator network 714 may generate an output file.

Quantum generator network 714 may transmit the output file to Quantum discriminator network 712. Quantum discriminator network 712 may take the output generated by quantum generator network 714 and reshape the file, as shown in convolution 1. Quantum discriminator network 712 may execute an upsample of the output file, as shown in convolution 2. Quantum discriminator network 712 may execute an additional upsample of the output file, as shown in convolution 3. Quantum discriminator network 712 may flatten the data. Quantum discriminator network 712 may output predictive solution 708. Predictive solution 708 may be the output file, output by quantum generator network 714. Predictive solution 708 may be distinguished by quantum discriminator network 712.

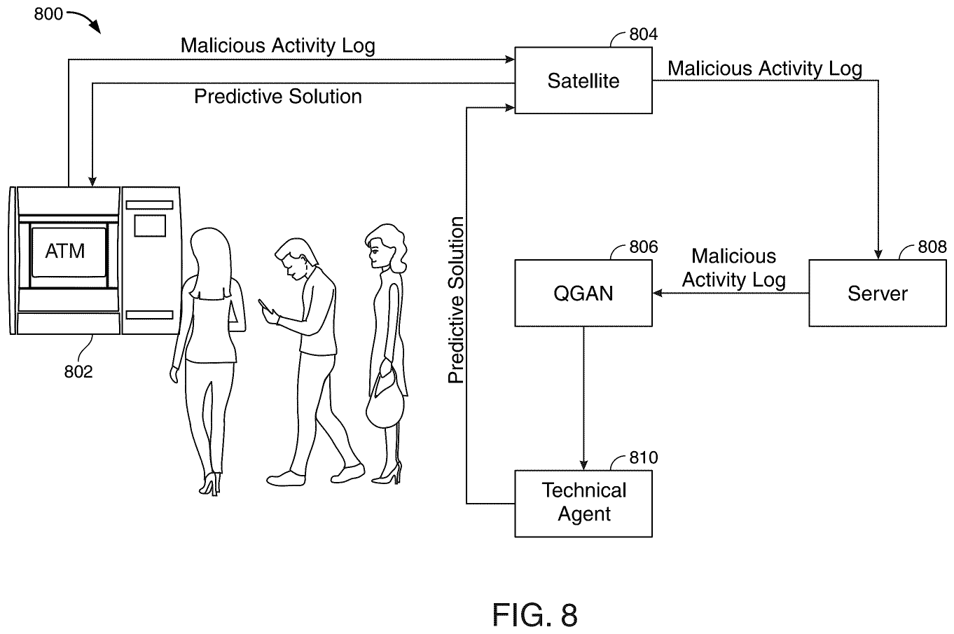

FIG. 8 shows an illustrative diagram. Diagram 800 shows ATM 802. User 812 may use ATM 802. User 814 may be a user of malicious intent. Camera 818, located within ATM 802, may record the environment of ATM 802. ATM 802 may create a malicious activity log. The malicious activity log may be transmitted to satellite 804. Satellite 804 may transmit the malicious activity log to server 808. Server 808 may transmit malicious activity log to QGAN 806. QGAN 806 may generate a predictive solution. The predictive solution may be a solution that may avoid executing the action of malicious intent. QGAN 806 may transmit the predictive solution to technical agent 810. Technical agent 810 may or may not approve the predictive solution. In an embodiment where technical agent 810 may not approve the predictive solution, QGAN 806 may generate a second predictive solution for approval. Upon approving the predictive solution, technical agent 810 may transmit the predictive solution to satellite 804.

Satellite 804 may transmit the predictive solution to ATM 802. ATM 802 may respond to user 812 based on the predictive solution. A response may include “unable to dispense funds”. As such, ATM 802 may deny processing the transaction, thereby avoiding executing malicious activities.

Thus, methods and systems for improving connectivity at ATMs to minimize ATM downtime are provided. Persons skilled in the art may appreciate that the present invention can be practiced by other than the described embodiments, which are presented for purposes of illustration rather than of limitation. The present invention is limited only by the claims that follow.

1. A system for improving connectivity at autonomous teller machine (“ATMs”) to minimize ATM downtime, the system comprising:
an ATM;
one or more satellite dishes;
a server, said server for processing a plurality of actions performed at the ATM;
one or more satellites, said one or more satellites for providing connection between the ATM and the server;
a decentralized end node, said decentralized end node for encrypting and decrypting an error log, said error log associated with an error discovered at the ATM; and
a technical agent;
wherein, when the ATM experiences a malfunction, the system is further operable to:
create an error log using the ATM;
transmit the error log to the server, said transmit via the one or more satellite dishes and the one or more satellites;
create a predictive solution, said predictive solution for solving an error associated with the malfunction, said create using the decentralized end node;
verify that the predictive solution solves the error, said verify via the technical agent;
transmit the predictive solution to the ATM, said transmit via the one or more satellite dishes and one or more satellites; and
execute the predictive solution at the ATM.

2. The system of claim 1 wherein the one or more satellites provides constant connection between the ATM and the server.

3. The system of claim 1 wherein the one or more satellites provides periodic connection between the ATM and the server.

4. The system of claim 1 wherein the one or more satellites provides a second connection between the ATM and the server, said second connection for instantiation when a primary connection fails.

5. The system of claim 1 wherein the one or more satellites:
is a lower orbit satellite; and
is registered with the ATM and the server.

6. The system of claim 1 wherein the decentralized end node is located remote from the ATM and the server.

7. The system of claim 1 wherein the error includes at least one of:
a configuration difficulty;
an internet connectivity difficult; and
an activity associated with a user of malicious intent.

8. The system of claim 1 wherein one of the satellite dishes is located at the ATM.

9. The system of claim 1 wherein one of the satellite dishes is located remote from the ATM.

10. The system of claim 1 wherein the technical agent is an artificial intelligence (“AI”) agent.

11. The system of claim 7 wherein when the error is an activity associated with a user of malicious intent, the predictive solution includes a response to a user that the ATM is unable to dispense funds.

12. A system for preventing malicious activity at an autonomous teller machine (“ATM”), the system comprising:
the ATM, wherein a user of malicious intent attempts to perform a malicious activity at the ATM;
a camera, said camera for detecting the user of malicious intent;
wherein the ATM includes a predetermined number of safety features and when said predetermined number of safety features are breached, the ATM is operable to generate a malicious activity log;
a decentralized end node, the decentralized end node for encrypting and decrypting the malicious activity log and data;
one or more satellites;
one or more satellite dishes, said one or more satellite dishes for transmitting the malicious activity log and the data to the one or more satellites;
a server for processing a plurality of actions performed at the ATM;
a quantum generative adversarial network (“QGAN”), including a quantum generator and a quantum discriminator; and
wherein, the quantum generator is operable to execute a forward propagation to output a predictive solution; and
wherein, the quantum discriminator is operable to execute a backward propagation to the predictive solution;
a technical agent for analyzing and approving the predictive solution;
wherein, when the technical agent approves the predictive solution, the system is further operable to transmit the predictive solution from the server to the ATM via the one or more satellite dishes and the one or more satellites; and
wherein, when the ATM receives the predictive solution, the ATM is further operable to execute any actions included within the predictive solution.

13. The system of claim 12 wherein the one or more satellites provides constant connection between the ATM and the server.

14. The system of claim 12 wherein the one or more satellites provides a secondary connection between the ATM and the server, said second connection for instantiation when a primary connection fails.

15. The system of claim 12 wherein the one or more satellites:
is a lower orbit satellite; and
is registered with the ATM and the server.

16. The system of claim 12 wherein the decentralized end node is located remote from the ATM and the server.

17. The system of claim 12 wherein one of the one or more satellite dishes is located at the ATM.

18. The system of claim 12 wherein one of the one or more satellite dishes is located remote from the ATM.

19. The system of claim 12 wherein the predictive solution includes a response to the user that the ATM is unable to dispense funds.

20. The system of claim 12 wherein the technical agent is an artificial intelligence (“AI”) agent.

21. A method for correcting an error located within an autonomous teller machine (“ATM”), the method comprising:
experiencing a difficulty at the ATM;
using one or more satellites in place of a first connection, said first connection experiencing the difficulty, using transmitting any transaction occurring at the ATM;
generating an error log, at the ATM, said error log including data relating to the difficulty;
transmitting, using one or more satellite dishes and one or more satellites, the error log to a server;
wherein, the server is associated with the ATM and the satellite;
encrypting the error log, said encrypting using a decentralized end node, said encrypting to prevent users of malicious intent from accessing the error log;
receiving, the encrypted error log at the server;
authenticating and decrypting the error log and a channel through which the error log was received;
executing a forward propagation of the error log, said executing at a quantum generator within a generative adversarial network (“QGAN”);
generating, from the forward propagation, a predictive solution;
executing a backward propagation of the predictive solution, said executing at a quantum discriminator within the QGAN;
approving the predictive solution, said approving at the quantum discriminator;
transmitting the approved predictive solution to a technical agent;
analyzing and approving the predictive solution at the technical agent;
transmitting the predictive solution to the ATM, said transmitting via the one or more satellite dishes and the one or more satellites; and
installing the predictive solution at the ATM.
